(19) United States
(12) Patent Application Publication
(10) Pub. No.: US 2015/0272167 A1
(43) Pub. Date: Oct. 1, 2015

(54) ADDITIVE FOR RUMINANT FEED

(71) Applicant: PURINA ANIMAL NUTRITION LLC, Shoreview, MN (US)

(72) Inventors: Larry Varner, New Braunfels, TX (US); Kent J. Lanter, Waterloo, IL (US)

(73) Assignee: PURINA ANIMAL NUTRITION LLC, Shoreview, MN (US)

(21) Appl. No.: 14/227,530

(22) Filed: Mar. 27, 2014

(51) Int. Cl. A23K 1/18; A23K 1/16; A23K 1/14

(52) U.S. Cl. CPC A23K 1/1813; A23K 1/14; A23K 1/1609

(57) ABSTRACT

Disclosed herein are ruminant feed compositions that include between 0.3% and 1.5% citric acid based on the total weight of the composition. Also disclosed herein is a method of attracting wild or semi-tame Cervidae employing a ruminant feed composition or attractant composition including between 0.3 wt % and 1.5 wt % citric acid based on the total weight of the composition. Also disclosed are edible paste compositions, edible foam compositions, and edible paste foam compositions for ruminants including between 0.3 wt % and 1.5 wt % citric acid based on the total weight of the composition.

### TECHNICAL FIELD

The present disclosure relates to feeding or attracting wild or semi-wild ruminant mammal of the family Cervidae in the wild, in a semi-enclosed space, or in a large enclosure.

### BACKGROUND

Food attractants are commonly employed for attracting wild or semi-tame animals to a selected location. For many species, food attractants are the most successful known means to attract a targeted animal. In the case of wild or semi-wild ruminant mammal of the family Cervidae, food is a highly successful attractant, particularly in the winter months when food sources for the deer become less plentiful, or in areas of high population density. Increasing the palatability of food attractants results in a greater number of Cervidae attracted to a selected location.

Additionally, in some cases nutritional deficiency of Cervidae is observed where, for example, one or more animals fail to consume a nutritionally adequate amount of feed during a selected period of time. Increasing the palatability of food sources encourages the animals to eat more food.

Additionally, in captive populations where one or more animals becomes sick or where wild populations suffer widespread illness, sick Cervidae may require more palatable feed in order to entice them to eat food in order to maintain or increase strength and ability to recuperate, or to entice them to eat food laced with medication, or both.

Finally, in captive populations of non-Cervidae ruminants, such as for example cows, increasing the palatability of food sources encourages the ruminant to eat more food. In sick ruminants, increased palatability may entice them to eat food in order to maintain or increase strength and ability to recuperate, or to entice them to eat food laced with medication, or both.

Thus it is desirable to provide enhanced food palatability, or provide food attractants with enhanced palatability, for ruminants. It is particularly desirable to provide enhanced food palatability, or provide food attractants with enhanced palatability, for wild or semi-wild ruminant mammals of the family Cervidae. Further, it is desirable that the palatability enhancing agents employed be nutritionally beneficial, easily incorporated into the food or food attractant, and be inexpensive.

### SUMMARY

Disclosed herein are ruminant feed compositions that include between 0.3% and 1.5% citric acid based on the total weight of the composition. Also disclosed herein are attractant compositions for wild or semi-tame Cervidae that include between 0.3 wt % and 1.5 wt % of citric acid based on the total weight of the attractant. Also disclosed herein is a method of attracting wild or semi-tame Cervidae employing a ruminant feed composition including between 0.3% and 1.5% citric acid based on the total weight of the composition or an attractant composition including between 0.3% and 1.5% citric acid based on the total weight of the composition. Also disclosed are edible paste compositions, edible foam compositions, and edible paste foam compositions for ruminants, including between 0.3% and 1.5% citric acid based on the total weight of the composition.

Also disclosed herein is a method of establishing a pattern of returning behavior in a wild or semi-wild ruminant mammal of the family Cervidae, the method including placing an edible composition at one or more selected locations within an open, semi-enclosed, or large enclosed area, the edible composition including at least one carbohydrate and about 0.3 wt % to 1.0 wt % citric acid based on the total weight of the composition; wherein the amount of the edible composition consumed by the Cervidae over a selected period of time is 1.1 to 10 times the amount consumed of the same composition without citric acid.

Also disclosed herein is a method of feeding wild or semi-wild deer, the method including providing a first deer feed and a second deer feed to a selected location within an open, semi-enclosed, or large enclosed area, wherein the difference between the first deer feed and the second deer feed consists of the inclusion of citric acid in the feed, the first deer feed having no citric acid, the second deer feed having about 0.3 wt % to 1.0 wt % citric acid; wherein the deer consume 1.1 to 10 times the amount of the second deer feed compared to the first deer feed over a selected period of time.

Additional advantages and novel features of the invention will be set forth in part in the description that follows, and in part will become apparent to those skilled in the art upon examination of the following, or may be learned through routine experimentation upon practice of the invention.

### DETAILED DESCRIPTION

### Overview

Various embodiments will be described in detail. Reference to various embodiments does not limit the scope of the claims attached hereto. Additionally, any examples provided herein are not intended to be limiting and merely set forth some of the many possible embodiments for the appended claims.

As used herein, the term “ruminant” generally means a mammal having a four-compartment stomach wherein the four parts of the stomach are the rumen, reticulum, omasum, and abomasum. In the first two stomach chambers, the rumen and the reticulum, the food is mixed with saliva and separates into layers of solid and liquid material. Solids clump together to form the cud or bolus. The cud is then regurgitated and chewed to completely mix it with saliva and to break down the particle size. Cellulose, hemi-cellulose, pectin, sugars, starches, and proteins are broken down in these chambers primarily by microbes (mostly bacteria, as well as some protozoa, fungi and yeast).

As used herein, the term “deer” or “Cervidae” generally means a ruminant mammal of the family Cervidae, including white-tail deer, mule deer, black-tail deer, elk, moose, red deer, caribou, fallow deer, roe deer, pudú, and chital.

As used herein, the term “about” modifying, for example, the quantity of an ingredient in a composition, concentration, volume, process temperature, process time, yield, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

As used herein, “edible composition” means a food item for a ruminant, or an attractant item for a wild or semi-tame ruminant. “Edible composition” includes “feed composition” and “attractant composition” as used in context. An attractant composition may, but does not necessarily, provide dietary nutrition, whereas a feed composition provides a substantial amount of dietary nutrition. By “substantial” it is meant that major dietary components including at least a carbohydrate source and a fat source are included in the composition; other components such as proteins, vitamins, trace minerals, and the like are optionally but not necessarily included. In some embodiments, the feed compositions and attractant compositions are referred to collectively herein as “edible compositions.”

Edible compositions further include “edible paste compositions”, which are edible compositions having one or more viscosifiers included therein; “edible foam compositions”, which are edible compositions having one or more foaming agents included therein; and “edible foam paste compositions”, which are edible compositions having one or more viscosifiers and one or more foaming agents included therein.

The edible compositions include between 0.3 wt % to 1.5 wt % citric acid as a percent of the weight of the composition, and one or more of a range of edible components known to be palatable to ruminants, for example deer. The feed compositions include, in various embodiments, from rough cut monolithic or bite size food components to pastes or gels containing dissolved or finely dispersed food components, and sizes of palatable items in between. All edible compositions include between 0.3 wt % to 1.5 wt % citric acid as a percent of the weight of the composition. The feed compositions of the invention have been shown to have a marked increase in palatability to deer over deer feeds known in the art, evidenced by the number of deer attracted and amount of feed eaten relative to feeds without citric acid added.

Increased palatability of the edible compositions leads to an improved ability to attract ruminants to a selected location.

Composition

The feed compositions of the invention include at least one carbohydrate, at least one fat, and between 0.3 wt % and 1.5 wt % citric acid as a percent of the weight of the feed composition. The at least one carbohydrate is present in a feed composition at about 10 wt % to 90 wt % based on the total weight of the feed composition, or about 15 wt % to 90 wt %, or about 20 wt % to 90 wt %, or about 25 wt % to 85 wt %, or about 30 wt % to 80 wt %, or about 35 wt % to 80 wt %, or about 40 wt % to 80 wt %, or about 45 wt % to 75 wt %, or about 50 wt % to 75 wt %, or about 50 wt % to 70 wt % based on the total weight of the feed composition, or any compositional amount within the range of 10 wt % to 90 wt % in 1 wt % increments (such as 16 wt % to 23 wt %, 84 wt % to 85 wt %, and the like). The at least one fat is present in a feed composition at about 0.1 wt % to 10 wt % based on the total weight of the composition, or about 0.25 wt % to 9 wt %, or about 0.25 wt % to 8 wt %, or about 0.25 wt % to 7 wt %, or about 0.25 wt % to 6 wt %, or about 0.50 wt % to 6 wt %, or about 0.50 wt % to 5 wt %, or about 0.50 wt % to 4 wt %, or about 0.50 wt % to 3 wt %, or any compositional amount within the range of 0.1 wt % to 10 wt % in 0.1 wt % increments (such as 0.3 wt % to 9.7 wt %, 2.6 wt % to 2.7 wt %, and the like).

The attractant compositions optionally include one or more carbohydrate and one or more fat, wherein the amounts thereof are not particularly limited but in some embodiments are encompassed by the ranges provided above. In other embodiments, the attractant compositions include at least one carbohydrate at about 10 wt % to 99 wt % based on the total weight of the attractant composition or any compositional amount within the range of 10 wt % to 90 wt % in 1 wt % increments (such as 3 wt % to 97 wt %, 20 wt % to 27 wt %, and the like).

Food components are employed as single components or in a wide variety of combinations that are not particularly limited by their recitation herein; it will be appreciated by those having skill that food components are selected for palatability to the targeted species and also for purpose. Examples of some purposes includes attraction of deer for hunting, behavior modification or training, basic nutrition, supplemental nutrition, easy to digest nutrition for sick animals, and the like. As such, any known combination of food components known to the palatable or attractive to the animal is suitably employed in the feed compositions or attractive compositions of the invention.

One suitable food component is a sugar-containing food component. Where employed in the edible compositions, a sugar-containing component is a carbohydrate source. One or more sugar-containing food components are usefully employed in the edible compositions of the invention. Sugar containing food components include, for example, molasses, honey, sugarcane, sugar beet, fruit, fruit portions, fruit extracts, and the like. In some embodiments, the sugar containing food source is dried prior to use; for example, molasses or honey may be further dried to remove water prior to use in the edible compositions of the invention. Where employed, the total amount of sugar-containing food components generally ranges from about 10 wt % to 90 wt % of a feed composition or attractant composition. In some embodiments, the sugar-containing food component includes one or more fruits, fruit portions, or fruit extracts that naturally contain citric acid. In such embodiments, it will be appreciated by those of skill that the amount of citric acid added along with the one or more fruits, fruit portions, or fruit extracts should be taken into account, and the amount of additional citric acid to include in the edible composition should be adjusted so that the total amount of citric acid is in the targeted range.

Where employed in a feed composition, a sugar-containing food component is present at about 10 wt % to 80 wt % based on the total weight of the composition, or about 15 wt % to 75 wt %, or about 20 wt % to 75 wt %, or about 20 wt % to 70 wt %, or about 20 wt % to 65 wt %, or about 25 wt % to 60 wt %, or about 25 wt % to 55 wt %, or about 25 wt % to 50 wt % based on the total weight of the composition or any compositional amount within the range of 10 wt % to 80 wt % in 1 wt % increments (such as 16 wt % to 23 wt %, 54 wt % to 75 wt %, and the like).

Another suitable food component is a C3-C7 sugar, a sugar alcohol, and combinations thereof. Where employed in the edible compositions, C3-C7 sugars and sugar alcohols are carbohydrate sources. One or more sugars, sugar alcohols, and combinations thereof are usefully employed in the edible compositions of the invention. Examples of suitable sugars include fructose, glucose, galactose, sucrose, maltose, and lactose, or two or more thereof. Examples of suitable sugar alcohols include adonitol, allitol, altritol, arabinitol, dulcitol, erythritol, galaxitol, glucitol, glycerol, iditol, inositol, isomalt, lactitol, maltitol, mannitol, perseitol, ribitol, rhamnitol, threitol, and xylitol or two or more thereof. Combinations of various sugar-containing food components, sugars, and sugar alcohols are suitably employed as food components in the feed compositions of the invention.

Where employed in an edible composition, a C3-C7 sugar, a sugar alcohol, or combinations thereof is present at a total amount of about 1 wt % to 80 wt % based on the total weight of the composition, or about 5 wt % to 75 wt %, or about 10 wt % to 75 wt %, or about 20 wt % to 70 wt %, or about 20 wt % to 65 wt %, or about 25 wt % to 60 wt %, or about 25 wt % to 55 wt %, or about 25 wt % to 50 wt % based on the total weight of the composition or any compositional amount within the range of 1 wt % to 80 wt % in 1 wt % increments (such as 6 wt % to 23 wt %, 74 wt % to 75 wt %, and the like).

Another suitable food component is whole grain, ground grain, or a grain component. Where employed in the edible compositions, a whole grain, ground grain, or a grain component is a source of carbohydrate, protein, fat, or all of these. One or more whole grains, ground grains, or grain components and combinations thereof are usefully employed in the edible compositions of the invention. Grain components include bran, germ, endosperm, or portions thereof. Suitable examples of grains include natural or genetically engineered grains including amaranth, barley, buckwheat, bulgur, corn, einkorn, farro, grano, khorasan grain, kaniwa, millet, oats, quinoa, rice, rye, sorghum, spelt, triticale, wheat (including durum wheat, and bread wheat including hard wheat, soft wheat, white wheat, red wheat, winter wheat, and spring wheat), and wild rice.

Where employed in an edible composition, the total amount of whole grain, ground grain, or a grain components is present at a total amount of about 5 wt % to 50 wt % of the edible composition, or about 10 wt % to 50 wt %, or about 10 wt % to 40 wt %, or about 15 wt % to 30 wt %, or about 20 wt % to 30 wt % of the total weight of the edible composition, or any compositional amount within the range of 5 wt % to 50 wt % in 1 wt % increments (such as 6 wt % to 8 wt %, 16 wt % to 52 wt %, and the like).

Another suitable food component is a plant-based oil. Where employed in the edible compositions, a plant-based oil is a source of fat. Oils derived from plants, and combinations of two or more such oils, include expressed oils, distilled oils, and extracted oils. In embodiments, suitable plant oils are extracted from the fruits or seeds of plants, and the oils may be classified by grouping oils from similar plants, such as “nut oils”, “citrus oils”, or “legume oils.” Examples of plant oils that are usefully employed as food components in the edible compositions of the invention include coconut oil, palm oil, corn oil, walnut oil, almond oil, acai oil, flaxseed oil, tung oil, avocado oil, apple seed oil, theobroma oil, grape seed oil, rice bran oil, shea butter, tea see oil, cottonseed oil, olive oil, peanut oil, rapeseed oil, sesame oil, soybean oil, sunflower oil, wheat germ oil, and mustard oil.

Where employed in an edible composition, the total amount of plant-based oil generally ranges from about 0.1 wt % to 10 wt % of the total weight of the composition, or about 0.25 wt % to 9 wt %, or about 0.25 wt % to 8 wt %, or about 0.25 wt % to 7 wt %, or about 0.25 wt % to 6 wt %, or about 0.50 wt % to 6 wt %, or about 0.50 wt % to 5 wt %, or about 0.50 wt % to 4 wt %, or about 0.50 wt % to 3 wt % based on the total weight of the composition, or any compositional amount within the range of 0.1 wt % to 10 wt % in 0.1 wt % increments (such as 0.3 wt % to 9.7 wt %, 2.6 wt % to 2.7 wt %, and the like).

Another suitable food component is a whole or ground legume, or an extract, or component thereof, including the oil thereof, and combinations of two or more thereof. Where employed in the edible compositions, a whole or ground legume, or an extract, or component thereof is a source of carbohydrate, protein, fat, or all of these. Examples of suitable legumes include peanuts, chickpeas, various common strains of beans and peas, fava beans, lentils, lima beans, lupins, mung beans, pigeon peas, runner beans, and soybeans. Where employed in an edible composition, the total amount of whole or ground legume, or an extract, or component thereof generally ranges from about 1 wt % to 75 wt % based on the total weight of the composition, or about 5 wt % to 60 wt %, or about 10 wt % to 50 wt % based on the total weight of the composition, or any compositional amount within the range of 1 wt % to 75 wt % in 1 wt % increments (such as 6 wt % to 23 wt %, 56 wt % to 68 wt %, and the like).

Another suitable food component is a whole or ground seed or an extract, or component thereof, including the oil thereof, and combinations of two or more thereof. Where employed in the edible compositions, a whole or ground seed or an extract, or component thereof is a source of carbohydrate, protein, fat, or all of these. Examples of suitable seeds include flax seed, safflower seed, sunflower seed, rapeseed including canola, and the like. Where employed in an edible composition, the total amount of whole or ground seed or an extract, or component thereof generally ranges from about 1 wt % to 50 wt % based on the total weight of the composition, or about 5 wt % to 40 wt %, or about 10 wt % to 50 wt % based on the total weight of the composition, or any compositional amount within the range of 1 wt % to 50 wt % in 1 wt % increments (such as 6 wt % to 23 wt %, 54 wt % to 55 wt %, and the like).

In some embodiments, the citric acid source includes fruit, fruit portions, or fruit extracts. In some embodiments, the citric acid source is isolated natural or synthetic citric acid provided as a dry powder to the edible compositions. In some embodiments, a combination of fruit, fruit portions, or fruit extracts with isolated citric acid is employed in the edible compositions. In various embodiments, the edible compositions include a total of about 0.3 wt % to 1.5 wt % citric acid. In some embodiments, the edible compositions include about 0.4 wt % to 1.0 wt %, or about 0.5 wt % citric acid, or any compositional amount within the range of 0.3 wt % to 1.5 wt % in 0.05 wt % increments (such as 0.45 wt % to 0.75 wt %, 0.90 wt % to 1.25 wt %, and the like).

The availability of isolated citric acid is an advantage of using citric acid as a palatant in the edible compositions. Citric acid is generally widely available, and is inexpensive relative to many known flavor additives useful in edible mixtures for ruminants, such as food or attractant mixtures.

It is surprising that citric acid is a palatant for ruminants. In particular, semi-tame or wild deer would not be expected to find citric acid palatable, since deer are not known to eat or to prefer citric acid-containing food in the wild. Deer are known to eat fruit, due primarily to the sugar content thereof. However, fruits known to be favored by deer include apples, persimmons and sumac heads. Apples and persimmons have a very small amount of citric acid, e.g. about 0.1 wt % or less. The bulk of deer diets consist of grasses and plants, particularly flowing plants and non-woody perennial plants; nuts; mushrooms; and when available, farm crops such as beans, legumes, potatoes, sweet potatoes, soybeans, wheat, rye, or any of the known edible grains generally used for livestock. Ruminants in general are not known to eat foods high in citric acid. Yet, we have found that inclusion of about 0.3 wt % to 1.5 wt %, for example about 0.4 wt % to 1.0 wt %, or even about 0.5 wt % citric acid to feed compositions result in a substantial increase in the amount of feed composition consumed by wild deer such as white-tailed deer.

In some embodiments, sodium chloride is included in the edible compositions of the invention. Where included, sodium chloride is present at about 0.1 wt % to 5.0 wt % based on the total weight of the composition, or about 0.5 wt % to 3.0 wt %, or about 1.0 wt % to 3.0 wt % based on the total weight of the composition.

In some embodiments, water is included in the edible compositions of the invention. Where included, water is present at about 1 wt % to 50 wt % based on the total weight of the composition, or about 5 wt % to 50 wt %, or about 10 wt % to 50 wt % based on the total weight of the composition, or any compositional amount within the range of 1 wt % to 50 wt % in 1 wt % increments (such as 6 wt % to 23 wt %, 54 wt % to 55 wt %, and the like).

It will be appreciated that in various embodiments, the edible compositions include food components that are bite size, or food components that are soluble in water or soluble in oil; or a combination of bite size food components and soluble food components; or food components of any size in between bite size and soluble, such as ground or particulate food components, chunks of food items, or a blend of any selection of such sizes. “Bite size” means a size suitable for a ruminant to eat a single item in a single bite. Any size food component that can be eaten by a ruminant is suitably employed in the edible compositions of the invention. In some embodiments the size is selected by the nature of the food component: thus, sugars are particulate and soluble; whole grains are sized according to their natural form; but ground grain or other processed food items are sized as selected by a user.

In some embodiments, one or more additives are included in various embodiments of the edible compositions of the invention. For example, preservatives, stabilizers, emulsifiers, and adjuvants are suitably included in various embodiments to the edible compositions. Such additives must be food safe for deer. The amount of the additive employed is determined by the nature of the material and conventional use levels.

Examples of suitable preservatives include sorbic acid, potassium sorbate, fumaric acid, propionic acid, and benzoic acid. Common antimicrobial preservatives include sorbic acid and its salts, benzoic acid and its salts, calcium propionate, sodium nitrite, sulfites (sulfur dioxide, sodium bisulfite, potassium hydrogen sulfite, etc.) and disodium EDTA. Antioxidants include BHA, BHT, TBHQ and propyl gallate. Other preservatives include ethanol and methylchloroisothiazolinone. Naturally occurring substances such as rosemary extract, hops, salt, sugar, vinegar, alcohol, diatomaceous earth and castor oil are also useful as preservatives in some embodiments of the foaming feed compositions. Another group of preservatives targets enzymes in fruits and vegetables that act on these plants after they are cut. For instance, the naturally occurring citric and ascorbic acids in lemon or other citrus juice can inhibit the action of the enzyme phenolase which turns surfaces of cut apples and potatoes brown. Vitamin C and Vitamin E are also sometimes used as preservatives.

Examples of suitable emulsifiers include egg yolk lecithin, mustard seed mucilage, soy lecithin, sodium stearoyl lactylate, and monoglyceride ester of diacetyl tartaric acid.

Examples of suitable stabilizers include those that prevent undesirable interactions within the edible compositions. For example, calcium sequestrants such as tetrasodium pyrophosphate are usefully employed to prevent interaction of calcium ions with other components of the edible compositions, thereby maintaining stability of the compositions.

Examples of suitable adjuvants include attractants such as pheromones and pheromone-containing substances including urine, estrous, and the like or other scents that are known to attract deer, for example to attract a buck to the estrous scent of a doe; vegetable or animal extracts that provide enhanced palatability, such as beef extract or fish oil; vitamins, minerals, salts, trace nutrients, or other elements or nutrients beneficial to deer; other compounds known to increase palatability to deer such as Maillard reaction products of various sugars and proteins; and the like.

In some embodiments, an attractant is, or includes, an airborne attractant; that is, one or more attractive compounds that are volatile at use temperatures, such that deer are able to detect the airborne compound(s) from some distance away from the edible composition. Pheremones and pheromone-containing materials as well as food-odor based attractants are useful airborne attractants and are usefully included in one or more edible compositions of the invention. Examples of useful airborne attractants include estrous, urine, and various food odors, such as plant extracts including e.g. essential oils of plants known to attract deer, nut extracts, seed extracts, volatile esters attributed to the odors of tender green plants, apples, persimmons, and the like. Airborne attractants are usefully included in both attractant compositions and feed compositions. Generally, airborne attractants are present in an edible composition at 0.0001 wt % to 5 wt % based on the total weight of the composition, or about 0.0001 wt % to 3 wt %, or about 0.0001 wt % to 2 wt %, or about 0.001 wt % to 2 wt %, or about 0.001 wt % to 1 wt % of the composition; the amount of any one airborne attractant will vary within these ranges depending on the identity of the airborne attractant. In embodiments, combinations of two or more such airborne attractants are suitably employed in an edible composition.

In some embodiments, an adjuvant is an acid other than citric acid. Ascorbic acid and propionic acid are examples of two acids that are suitably included in the edible compositions of the invention. Where employed, ascorbic acid or propionic acid are present in the edible compositions at about 0.05 wt % to 2 wt % based on the total weight of the composition, or about 0.1 wt % to 1 wt %, or about 0.2 wt % to 0.3 wt %, or any compositional amount within the range of 0.05 wt % to 2 wt % in 0.05 wt % increments (such as 0.10 wt % to 0.15 wt %, 0.15 wt % to 1.25 wt %, and the like).

In some embodiments, the adjuvant is one or more additional palatants. Citric acid is a palatant; additional palatants are suitably included in the edible compositions of the invention. Suitable additional palatants include vegetable or animal extracts, such as beef extract or fish oil; vitamins, minerals, salts, trace nutrients, or other elements or nutrients beneficial to the selected animal; or other compounds or mixtures thereof known to increase palatability to the selected animal. Additional palatants include Maillard reaction products of various sugars and proteins, and the like. In some embodiments, one or more additional palatants or a component thereof can become airborne and thus serve as an airborne attractant to the selected animal. For example, it is known by those of skill that Maillard reactions give rise to a complex combination of compounds, some of which become airborne to provide attractive aromas and some of which are flavor compounds that are not volatile. Such aromas are usefully employed in some embodiments of the invention to increase the amount of the aroma released into the environment in a selected period of time, which in turn causes the aroma to provide a threshold aroma level over a larger area. The threshold aroma level is the minimum concentration of an aroma in the air that is noticeable by the selected animal.

In some embodiments, the edible composition is in the form of a paste. Pastes are particularly useful in formulating attractant compositions of the invention. The edible paste compositions have a paste-like viscosity that is provided, in embodiments, by blending small particulate or water-soluble food components and citric acid with one or more viscosifiers and water. In embodiments, the viscosifiers are activated, or “set up”, by heat; in such embodiments, all components are suitably blended in a low viscosity mixture, and then the mixture is heated to provide the targeted paste-like viscosity, also referred to herein as “set up”. In some embodiments, heating is followed by cooling before set up is observed. Useful viscosifiers for forming an edible paste composition include any of the known food-safe viscosifiers. In some embodiments, two or more viscosifiers are employed in combination, particularly where a combination of properties is desirable. Suitable viscosifiers include gums, starches, inorganic colloids such as certain clays, and plant-based thickeners commonly employed in food.

Examples of suitable viscosifiers for use in the edible paste compositions of the invention include xanthan gum, locust bean gum, agar, carrageenan, alginic acid, sodium alginate, calcium alginate, gum Arabic, gum ghatti, gum tragacanth, karaya gum, guar gum, chicle gum, dammar gum, glucomannan, psyllium seek husks, spruce gum, tara gum, gellan gum, arrowroot, corn starch, β-glucan, various types of cellulose or methyl cellulose, pectin, potato starch, gelatin, chondrin, press cake from Irvingia gabonensis, gum karaya, gulaman, montmorillonite clays, bentonite clays, attapulgite clays, and the like.

It will be appreciated that different viscosifiers will be required at different levels, depending on efficacy in the particular combination targeted, and desired consistency. In some embodiments, the amount of viscosifier employed in the edible paste compositions is between about 0.001 weight percent (wt %) to 5 wt % of the composition, for example about 0.005 wt % to 3 wt %, or about 0.01 wt % to 2 wt %, or about 0.05 wt % to 1 wt %, or about 0.005 wt % to 1 wt %, or about 0.01 wt % to 0.5 wt %, or about 0.005 wt % to 0.5 wt %, or about 0.01 wt % to 0.1 wt %. In some embodiments, the amount of water in the edible paste compositions is about 10 wt % to about 50 wt %, or about 15 wt % to 40 wt %, or about 20 wt % to 30 wt %. The food components, plus any additional ingredients such as adjuvants, fillers, and the like, make up the balance of the edible paste compositions.

In some embodiments, the viscosifier is dissolved in water and crosslinked to provide high viscosity, such as by dissolving sodium alginate in water then adding a source of calcium to induce ionic crosslinking. In other embodiments, heat is required to dissolve the viscosifier and give rise to high viscosity, such as by using gelatin. In some embodiments, the viscosifier is a blend of two or more of these materials or a blend of these with additional additives known to interact with the viscosifier(s) to increase viscosity further or affect other properties in a manner that is advantageous for the edible paste compositions.

In some embodiments, the selected viscosifier exhibits hysteresis. One example of a viscosifier that exhibits hysteresis is agar. Dissolved at 1%-2% w/v in boiling water, agar forms a transparent, firm, shear resistant gelatinous medium upon subsequently reaching 32° C.-40° C. Lower viscosities are achieved at lower amounts of agar, such as between 0.01%-0.9% w/v. However, once set up, the agar does not “melt” or become re-liquefied at 32° C.-40° C. Rather, the set up agar must be reheated to about 85° C. (185° F.) in order to liquefy. Some softening may occur starting at about 65° C. (149° F.). The phenomenon wherein a set up or gelled mass melts, or liquefies, or undergoes a reduction in viscosity at a different temperature from that at which it sets up is known as hysteresis.

In some embodiments, the viscosifier exhibits pseudoplastic behavior. One example of a viscosifier that exhibits pseudoplastic behavior in the edible paste compositions is xanthan gum. Xanthan is typically supplied as a powder. The powder is simply added to an aqueous medium to form the gum, wherein swelling occurs slowly over a period of time at ambient temperature. Xanthan gum produces a large increase in the viscosity at very small quantities, on the order of 0.5% or less by weight in water. Xanthan gum also has a characteristic tendency to prevent formation of ice crystals in frozen food compositions, providing a pleasant creamy texture to cold foods, and thus is useful in some embodiments of the edible paste compositions of the invention wherein cold environments, e.g. below 0° C. are expected. The viscosity of xanthan gum solutions decreases with higher shear rates; this is called shear thinning or pseudoplasticity. This means that a product subjected to shear, whether from mixing, shaking or even chewing, will thin out, but once the shear forces are removed, the substance will immediately thicken back up.

Unlike many other viscosifiers, xanthan gum is very stable under a wide range of both temperature and pH, notably stable to pH of 2 for example. Xanthan gum requires no heat in order to build viscosity. Xanthan gum is easily dispersed in an oil or glycol component, prior to addition of water, and thus may be premixed with one or more food components for ease of mixing and to avoid formation of clumps when water is added to form a slurry. Where the pH of the paste feed is lower than 5, due for example to the addition of citric acid to the edible paste compositions, it is advantageous to include xanthan gum in order to maintain higher viscosity.

In some embodiments, one or more of locust bean gum or guar gum are usefully employed as a viscosifier in the edible paste compositions. Locust bean gum and guar gum are seed gums produced by removing the outer coating of a seed, and grinding its endosperm. Both locust bean gum and guar are non-ionic galactomannans, that is, polysaccharides including galactose and mannose units. Guar gum has a mannose:galactose ratio of about 2:1 while locust bean gum has a mannose:galactose ratio of about 4:1. Locust bean gum in particular is useful for low temperature applications, for example where the thickened foam feed compositions are employed during winter months in cold climates. Locust bean gum is used in the edible paste compositions at about 0.01 wt % to about 1.0 wt %. In some embodiments, the edible composition is slurried with the locust bean gum, then the slurry is heated to at least about 47° C. to dissolve the gum, giving rise to an edible paste composition.

In some embodiments, one or more carrageenans are usefully employed as viscosifiers in the edible paste compositions. Carrageenans are a family of linear, high-molecular-weight sulfated (anionic) polysaccharides that are extracted from red edible seaweeds. The carrageenan polysaccharide chains are made up of galactose and 3,6 anhydrogalactose (3,6-AG) units, sulfated and nonsulfated. Carrageenans bind strongly to proteins. There are three main varieties of carrageenan, which differ in their degree of sulfation. Kappa-carrageenan has one sulfate per disaccharide and forms hard, rigid gels in the presence of potassium ions. Iota-carrageenan has two sulfates per disaccharide and forms soft gels in the presence of potassium ions. Lambda-carrageenan has three sulfates per disaccharide and increases viscosity but does not gel. In embodiments, carrageenans are used in the edible paste compositions at about 0.01 wt % to about 2.0 wt %. The carrageenans have nearly Newtonian rheological properties at the lower concentrations, with shear thinning properties (pseudoplasticity) developing at higher concentrations. In some embodiments, the edible composition is slurried with the carrageenan, then the slurry is heated to at least about 40° C. to dissolve the gum, for example where potassium or calcium salts of the sulfate groups are employed. In other embodiments, no heat is employed to form the edible paste compositions.

In some embodiments, a combination of viscosifiers is employed in the edible paste compositions. In particular, it is desirable in some embodiments to use two or more viscosifiers to impart desirable properties to the edible paste compositions, such as heat-induced set up and pseudoplasticity; or hysteresis and pseudoplasticity, or partial set up without heat, followed by complete set up with addition of heat, or some other combined set of properties desirably imparted by a blend of viscosifiers.

The edible paste compositions of the invention, once set up, have viscosity of at least about 10,000 centipoise (cP), and as high as about 5,000,000 cP; in some embodiments, the edible paste compositions have a viscosity of about 50,000 cP to 3,000,000 cP, or about 100,000 P to 2,000,000 cP, or about 200,000 cP to 1,000,000 cP, or about 500,000 cP to 3,000,000 cP or about 1,000,000 to 4,000,000 cP, or about 2,000,000 cP to 4,000,000 cP. In some embodiments, the viscosity of the edible paste compositions varies less than about 50% between 20° C. and 50° C., for example less than about 40% between 20° C. and 50° C., or less than about 30% between 20° C. and 50° C., or less than about 25% between 20° C. and 50° C., or less than about 20% between 20° C. and 50° C., or less than about 10% between 20° C. and 50° C.

In some embodiments, the edible paste compositions have a Newtonian viscosity profile. In other embodiments, the edible paste compositions are thixotropic or pseudoplastic. In some embodiments, the edible paste compositions include a viscosifier that exhibits hysteresis. The viscosity profile of the edible paste composition is primarily dictated by the type and amount of the viscosifier employed in the composition, but in some embodiments is strongly influenced by the food components of the composition, the pH of the composition, or both.

In some embodiments, the edible compositions include compounds or reactive blends of compounds that cause foaming. In such embodiments, the feed composition is an edible foam composition. Foaming is preferably carried out when water is included in the composition; in such embodiments, the feed composition is an edible foam composition. In some embodiments, foaming is carried out when water plus a viscosifier is included in the composition. In such embodiments, the feed composition is an edible foam paste composition. In some embodiments, the foaming agent is combination of citric acid/sodium bicarbonate.

The edible foam compositions provide for the increased amount of aromas or other volatile compounds released from the edible foam composition by forming gas bubbles that entrain volatile compounds, wherein the burst bubbles then release the molecules into the environment. Food odors or other odors or volatile attractants such as pheromones are advantageously dispersed using the edible foam compositions. In embodiments, effective amounts of one or more attractive odors are dispersed over a larger area due to increased amounts of the odors being released in a selected period of time when compared to feed compositions that do not foam.

The type of foaming agent employed in the edible foam compositions is not particularly limited. Suitable foaming agents include propellants, propellants in combination with nucleating agents wherein the nucleating agent is added by the end user to accelerate foam formation, and components employed by end users to initiate two-part foam-forming reactions. In some embodiments the foaming agent is a propellant, wherein the edible foam composition is provided in a pressurized package and, upon the user dispensing the composition onto or into a substrate, the propellant expands and the foam is formed by the expansion. Such packaging and dispensing technologies are well known in the industry and any of the known packaging or dispensing mechanisms employed to provide pressurized propellant-containing liquid compositions is suitably employed in conjunction with the foaming feed compositions containing propellant. In some embodiments, the propellant is carbon dioxide or nitrous oxide.

In some embodiments, the foam is formed by a two-part foam-forming reaction. In such embodiments the user combines the contents of a two-part package, or kit, to start the reaction and initiate foaming. In some such embodiments the combining is done at the same time as the dispensing of the edible foam composition. In some such embodiments suitable packaging systems for contemporaneous mixing and dispensing of a two-part system are advantageously employed. In some embodiments the two-part package includes a first part including at least water, one or more food components, and a first compound that can participate in a gas-forming reaction; a second part includes at least a second compound that can participate in a gas forming reaction with the first compound. In some such embodiments, the second part further includes water, one or more food components, or both.

In various embodiments described below, a two-part mixture that when combined forms an edible foam mixture is not an edible foam mixture prior to the mixing of the two parts. In such embodiments, one or more parts thereof may be referred to as an “edible foam premix”, wherein in some embodiments the premix contains at least water and one or more food components.

In some embodiments, the foam forming chemical reaction is accomplished by a reactive combination that undergoes a reaction to form a gas, and the gas forms the foam in the edible foam composition. The reactive combination includes a first reactive component and second reactive component, wherein the reactive combination is formed by an action taken by an end user. The first reactive component, second reactive component, or both include a single compound or a mixture of two or more compounds. In some embodiments, the first reactive component is present in an edible foam premix, and the user adds the second reactive component to the premix to form the edible foam composition. In such embodiments, the second reactive component can be included as an “activator” in a kit, the kit containing the edible foam premix and the activator, the activator designed and adapted to add to the premix using one of the packaging embodiments and one of the methods of addition and mixing described herein.

In other embodiments, both reactive components are added by the end user to the edible foam premix in order to form the edible foam composition. In some such embodiments, the two reactive components are supplied in two activator packages, as part of a kit that includes the edible foam premix, wherein the reactive components are mixed prior to or contemporaneously with the addition of the mixture to the edible foam premix; in other such embodiments the two reactive components are provided in a single activator package as a mixture, wherein the mixture is triggered to react by dissolution in the water provided in the edible foam premix. For example, in some embodiments an activator is two powdered compounds that undergo an acid-base reaction, wherein the two compounds are safely commingled in a dry mixture, further wherein upon dissolution in water the acid-base reaction is initiated. In another such embodiment, a compound that reacts with water to form a first reactive compound may be safely packaged with the second reactive compound in a dry mixture, and provided as an activator in a kit that also includes the edible foam premix. In yet other embodiments, an edible foam premix is a combination of one or more food components, the first reactive component, and the second reactive component, and water is the activator as supplied in a kit. In yet other embodiments, an edible foam premix is a combination of one or more food components and the first reactive component, wherein water and the second reactive component combined form the activator that is supplied, together with the edible foam premix, in a kit.

Suitable examples of reactive combinations include salts of carbonic acid as one reactive component and a Bronsted-Lowry (protic) acid as the other reactive component, wherein the reaction thereof yields carbon dioxide gas and the salt of the acid. The strength of the acid required to provide the reaction is determined by the particular salt species employed in such reactions. Thus, for example, sodium carbonate or sodium bicarbonate undergo reactions with weak protic acids to yield carbon dioxide and the sodium salt of the acid. Weak protic acids include organic acids such as acetic acid, propionic acid, butyric acid, lactic acid, tannic acid, malic acid, gluconic acid, glycolic acid, pyruvic acid, glutamic acid, fumaric acid, succinic acid, citric acid, isocitric acid, pimelic acid, linear polycarboxylic acids such as oxalic acid, malonic acid, succinic acid, glutaric acid, and adipic acid; and anhydrides that break down into acids on contact with water, such as acetic anhydride, butyric anhydride, malonic anhydride, or succinic anhydride; and combinations of two or more thereof. In various embodiments the carbonate or bicarbonate salt is a lithium, sodium, potassium, magnesium, or calcium salt, or a mixture of two or more thereof. The acid used to liberate carbon dioxide is selected by the user based on reactivity and edibility and/or palatability of the resulting salt that forms in the reaction with the carbonate species.

In some embodiments wherein the first reactive component is present in an edible foam premix and the second reactive component is added to the composition to form the edible foam composition, a carbonate or bicarbonate is the first reactive component and the acid or anhydride is the second reactive component. In other such embodiments, the acid or anhydride is the first reactive component and a carbonate or bicarbonate is the second reactive component. In some embodiments, a bicarbonate or carbonate are provided in one mixture with an anhydride, wherein the mixture is supplied in dry form in a package separate from an edible foam premix that includes at least the water and one or more food components.

In some embodiments, the edible foam premixes or edible foam compositions include a total of about 0.3 wt % to 1.5 wt % citric acid for use as a palatant. Citric acid is also usefully employed as a first reactive component, that is, it is added to a edible foam premix, whereas sodium carbonate or sodium bicarbonate is advantageously employed as the second reactive component that is added to the edible foam premix by the end user. In embodiments where citric acid is employed as a reactive component, the amount employed is adjusted to include the stoichiometric amount required to react with a carbonate or bicarbonate, or the stoichiometric amount plus an additional 0.3 wt % to 1.5 wt % based on the weight of the edible foam composition or of the premix.

In one embodiment, citric acid and sodium bicarbonate are provided as the first and second reactive component, respectively, wherein both reactive components are blended in dry form. The edible foam premix includes water, one or more food components, and optionally additional citric acid, a viscosifier, or both. The end user then adds the reactive component blend to the premix in order to start the foaming reaction. In some embodiments, the first reactive component, second reactive component, or both are provided in a slow-release form, wherein the materials are encased within a coated pellet, granule, tablet, and the like. In some embodiments, the coating provided on the pellet, granule, tablet or the like is a water soluble or water swellable polymer, such that the polymer slowly dissolves upon addition of the coated pellet, granule, tablet or the like to an edible foam premix and foaming action is initiated upon contact of the water with the first reactive component, second reactive component, or blend thereof. Such water soluble or swellable coatings are known in the industry and any such coatings are usefully employed herein. In some embodiments, a portion of the first reactive component, second reactive component, or both are provided in a slow-release form, and the remainder of one or more reactive components are provided without a protective coating in order to initiate some amount of immediate foaming upon contact with water or with the other reactive component.

The packaging employed in dispensing a two-part reactive component system is not particularly limited. In some embodiments, the edible foam premix and the activator, together with the packaging thereof, form a kit that is provided to an end user. In some embodiments, the user simply opens two packages and dispenses the contents thereof into a container such as a flask, bottle, or bucket and mixes the contents by hand before applying the edible foam composition to the desired surface. In other embodiments, special packaging is employed to mix the two reactive components within a supplied package prior to dispensing, such as a single package with a perforatable membrane between the parts and a nozzle to dispense the mixed components onto the selected surface; or a bottle of edible foam premix provided with a small package of powder the user is directed to add to the liquid contents of the bottle, wherein the bottle is shaken and then the contents applied to the selected surface. In some embodiments, the dispensing mechanism is a static mixer, such that mixing and dispensing of premix and activator is carried out contemporaneously. In some embodiments, the two part mixture is mixed and the left in the provided package, wherein the foaming reaction and concomitant volume increase of the edible foam composition causes the edible foam composition to move out of the package through an opening adapted for the dispensing.

In some embodiments the edible foam compositions further include one or more foam stabilizers. “Foam stabilization” means to slow the rate of eruption of the bubbles present in the foam, regardless of the mechanism of their formation. “Foam stabilizers” or “foam stabilizing agents” are thus any material or compound that serves to slow bubble eruption of the foam, prolonging foam lifetime. In some embodiments, the foam stabilizer is a nonionic surfactant. Suitable nonionic surfactants include, for example, ethoxylated fatty alcohols, fatty acid alkanolamides, fatty amine oxides, octyl- or nonylphenol ethyoxylates, and sorbitan esters and their ethoxylates such as polyoxyethylene (20) sorbitan monooleate; many others are known and used in the food industry for foam stabilization. In embodiments, the foam stabilizer is a food-safe surfactant or a GRAS surfactant. In some embodiments where the edible foam composition is an edible foam paste composition, the viscosifiers employed to form the paste are also foam stabilizers; viscosifiers are described in detail below. In some embodiments, the foam stabilizer is a blend of two or more foam stabilizers, for example, a combination of a viscosifier and a nonionic surfactant, or two surfactants, or two viscosifiers.

Method of Making

The edible compositions are easy to make employing known industrial techniques and equipment. Both batch and continuous modes of manufacturing are advantageously employed by those of skill. In some embodiments, a slurry is formed prior to forming a edible paste composition. A slurry is formed when at least one of the food components and a viscosifier are combined with water but the viscosity is not yet elevated to its final selected end point. In some embodiments, the dry ingredients, which include in some embodiments one or more food component(s), one or more viscosifiers, and one or more adjuvants, are blended together, followed by addition of water to the dry ingredients to form a slurry. In other embodiments, one or more dry ingredients are added directly to water.

In some embodiments, slurry formation is followed by addition of heat to complete mixing or to set up the paste where one or more viscosifiers are included in the edible compositions. “Set up” is where the heat added is sufficient to cause the viscosifier to raise the viscosity of the slurry to a selected end point. Heating the slurry includes adding heat sufficient to raise the temperature to about 30° C. to 100° C., or even above 100° C. if the vessel containing the slurry is enclosed such that pressure is suitably applied. The amount of time during which heat is applied is determined by the specific ingredients included in the edible composition and the nature of the processing involved, e.g. batch vs. continuous mode, size of a batch etc. In other embodiments, no heat is added; the edible composition is formed at ambient temperatures ranging from about 15° C. to 30° C. In some such embodiments, the edible composition is packaged either before heating, or while the heated composition is still at a temperature above the temperature where set up is observed in the case of edible compositions containing viscosifiers.

In some embodiments, a method of making an edible paste composition includes mixing a sugar, sugar alcohol, or sugar-containing product with water in a vessel to form a solution; adding one or more viscosifiers to the solution to form a slurry; mixing one or more optional additional food components and citric acid into the slurry; heating the slurry to form an edible composition; removing the heat source from the feed composition; and pouring the feed composition from the vessel into two or more containers; wherein upon cooling to a selected temperature, the feed composition sets up to form a paste having a selected viscosity. The selected temperature and viscosity will depend on the type and amount of viscosifier, or blend thereof, employed in the composition.

In some embodiments the edible compositions are formed as masterbatches, and the masterbatches are subsequently packaged for individual use. A masterbatch is a batch composition having a volume of greater than about 20 liters, wherein the volume is not particularly limited as to upper range of size and could include e.g. a tanker or truckload. The masterbatch is packaged for shipment and/or storage. In some embodiments where heat is employed to cause set up of an edible paste composition, a slurry is formed in masterbatches, wherein the blending of the masterbatch does not employ the addition of heat. At a selected time, the masterbatch is heated as a single batch, as part of a continuous process, or by breaking the masterbatch into several small batches. The heat added to the masterbatch is sufficient to cause the composition to set up upon heating or upon subsequent cooling. Before heating, or after heating but prior to setup, or after blending the components at ambient temperature (about 15° C. to 30° C.) the masterbatch is divided into smaller batches or individual containers.

The individual containers having an edible composition of the invention contained therein are intended for an end user to carry to a selected location and apply in a manner selected by the user and appropriate to the viscosity and foam presence in the particular edible composition. The individual containers hold about 1 mL to 10 liters, or about 100 mL to 5 liters, or about 1 liter to 10 liters of the edible composition. In some embodiments, the individual containers are cups or buckets, with lids that are removable and reusable. In some embodiments, the individual containers are elongated cylindrical tubes having a nozzle on one end and a movable plunger on the other end, wherein the tube is adapted for use with a caulk gun type apparatus. In some embodiments, the individual container is a toothpaste tube having a collapsible body and a removable and reusable cap that is snapped on or screwed on. In some embodiments, the individual container is a sealed sleeve formed from a thermoplastic film, such as polyethylene, polypropylene, or polyester film, and the film is adapted to be cut open on one end and the feed composition urged out of the tube by the end user collapsing or rolling the tube on the end opposite from the cut end.

In some embodiments, the edible composition components are formulated in a single batch or in a continuous process and are loaded directly into individual containers. In some embodiments, rather than employ a masterbatch, the individual containers are filled with the feed composition directly. In some embodiments where heat is required to set up an edible paste composition, the containers are filled prior to heating, and the heating is carried out in the individual container.

In some embodiments, the edible composition is added to a medium other than an individual container for an end user to use. For example, in some embodiments the edible composition is tumbled or mixed with a medium such as hay, woven or nonwoven fabric, sticks, wood fibers, plastic netting or mesh, and the like, to disperse the edible composition within the medium. In some such embodiments, the edible composition is heated to cause set up prior to mixing with the medium. In some embodiments, a slurry composition is mixed with the medium and then the combined composition and medium is heated to cause set up of the edible paste composition.

Method of Using

It is a feature of the present invention that the edible compositions are easy to use by an end user; in some embodiments, the edible compositions are used in the same way as conventional deer feed compositions. Where the end user employs a cup or bucket of the edible composition, in some embodiments the edible composition is simply set out as is, within the bucket or cup. In other embodiments, a paint mixing stick, spatula, knife, scoop, spoon, brush, or roller, or two or more of these are useful to meter out portions of the edible composition and spread it onto a selected surface. The edible composition is applied to the selected surface in any desired amount. Very thin layers, for example 1 mm or less, are applied to a selected surface in some embodiments. Thick or layers, greater than 1 mm and up to any desired thickness, for example about 2 mm to 10 cm, or about 2 mm to 5 cm, or about 2 mm to 1 cm are easily applied with ease to any selected surface.

The viscosity of the edible paste compositions are sufficient to prevent gravity-assisted flow at temperatures as high as 50° C. to 85° C., or 60° C. to 80° C., or 65° C. to 75° C., or 50° C. to 70° C., yet the edible paste composition is easily applied to a variety of surfaces by use of shear or extension force applied by a user. As discussed above, in some embodiments the edible paste composition includes a viscosifier that is pseudoplastic; in some such embodiments, shear applied by the end user during application is sufficient to cause significant thinning of the composition, making it easy to work and apply. The pseudoplastic property also causes the composition to “set up” again immediately upon cessation of the shear force, so that the composition stays in the selected location even on vertical surfaces. The edible paste composition will not melt, flow, or sag once in place, even when placed in direct sunlight at temperatures as high as 50° C. or more, in some embodiments as high as 85° C. This advantage prevents loss of the product during warm days and in direct sunlight.

In embodiments where the edible composition is an edible paste composition, the selected surface may be horizontal, vertical, or anywhere in between. If desired, the edible paste composition can be worked into the crevice of a knothole of a tree, into the gaps and crevices between rough or peeling bark and a tree trunk, into crevices between rocks or into pits, cracks, fissures, or other natural features in rocks, into the crotch of a tree branch point, or into some portion of a man-made apparatus.

The edible paste compositions of the invention remain as applied within cracks, crevices, convolutions, folds, pits, and the like within a selected surface and do not flow out, thereby providing the possibility of longer-term attraction of deer to the selected location. Some portion of the edible paste compositions of the invention can be made to remain at the selected location for days or even weeks after application to the selected surface, because the animal cannot reach it and the composition does not flow out. In some embodiments, even where the majority of the actual food product(s) have been consumed, there is a sufficient amount of the edible paste composition residing within one or more cracks, crevices, and the like to attract the animal, for example via the odor thereof.

In one method, an edible composition of the invention is used to establish a pattern of behavior in a wild or semi-wild animal wherein the animal is conditioned to return to a selected spot on a repeated basis. A wild animal is an animal that is not conditioned to accept or expect human interaction. A semi-wild animal is an animal that has been conditioned to accept or expect limited human interaction, for example bottle-feeding, hand feeding, and the like. The edible compositions of the invention are useful to establish such behavior patterns in wild or semi-wild animals in open, semi-enclosed, or large enclosed areas. A semi-enclosed area is an area that includes one or more fenced regions wherein the fenced regions are not fully enclosed. Typically, but not always, the fenced areas in a semi-enclosed area describe land areas larger than 1 acre, and up to 10 acres, or up to 100 acres, or up to 1000 acres, or even larger. Enclosed areas are small in some embodiments, for example between about 1 acre and 10 acres, and are large in other embodiments, for example about 100 acres up to 1,000 acres, or 10,000 acres, or 100,000 acres or more.

In some embodiments, the targeted area is an enclosed area that is stocked with deer, for example for hunting purposes. In one representative example, an enclosed area including about 1000 acres of land may have 1000 or more semi-tamed deer stocked within the area. In other embodiments the targeted area is an open area where deer are scarce. In one representative example, in open area of about 1000 ac.² includes between 1 and 10 wild deer. In yet some other embodiments, the targeted area is a semi-enclosed area that is set up to concentrate a wild population of deer and limit their movement once within the boundaries of the partial enclosure. An unlimited number of combinations of land and enclosure sizes and types exist, as well as degree of proliferation of deer, as will be appreciated by one of skill. It is a feature of the invention that all such combinations are addressed using the edible compositions of the invention to a greater extent than with previous food attractants, due to the desirability of the citric acid-containing compositions to deer.

The edible compositions and the edible paste compositions can further be made to foam, wherein eruption of the foam bubbles provide an increased amount of surface area to disperse the scent of one or more components of the edible composition, including any adjuvant such as an attractant scent added to the edible composition (e.g. urine, estrous, other pheremone, essential plant oils, and the like), from the selected location where the edible composition is applied. The foaming action also provides an additional means to force the edible foam paste composition into the cracks, crevices, etc. where the deer cannot reach it, thereby increasing longevity of the composition even further.

The cumulative effect of these advantages is an increased ability to attract deer to a selected location. This in turn allows the user to obtain animal behavior modification such as repeat visits by one animal or a group of animals with superior results. Establishing a pattern of behavior of deer in an open, semi-enclosed, or large enclosed area is thereby accomplished with ease.

Additional odor attractant imparted by the edible foam compositions and edible foam paste compositions increases the user's ability to attract deer. And the durable viscosity of the edible paste compositions (whether or not in foam form) act to attract or enrich the targeted animal for about 1 to 30 days after application to the selected location, for example about 2 to 25 days after application to a selected surface, or about 2 to 20 days after application, or about 2 to 15 days after application, or about 2 to 12 days after application, or about 2 to 10 days after application, or about 2 to 25 days after application, or about 4 to 25 days after application, or about 7 to 25 days after application, or about 10 to 25 days after application, or about 15 to 25 days after application, or about 15 to 21 days after application.

In some embodiments, the edible compositions of the invention are used to establish a pattern of returning behavior in a wild or semi-wild ruminant mammal of the family Cervidae, wherein 1 to 1000 animals, or 10 to 500 animals, or 10 to 100 animals, or 1 to 25 animals, or 1 to 10 animals are conditioned to return to the selected location having the edible composition applied thereto on a repeated basis after 1 application of the edible composition, or after 1 to 2 applications, or after 1 to 5 applications, or after 2 to 5 applications of the edible composition to the selected location. In some embodiments the “selected location” is a single point location, that is, a single selected surface; in other embodiments, it is between 2 and 10 selected surfaces within a 1 mile radius, or 2 to 100 selected surfaces within a 1 mile radius. In some such embodiments, the selected location is an open, semi-enclosed, or large enclosed area.

In some embodiments, a method of establishing a pattern of returning behavior in a wild or semi-wild ruminant mammal of the family Cervidae includes placing an edible composition at one or more selected locations within an open, semi-enclosed, or large enclosed area, the edible composition including at least one carbohydrate and about 0.3 wt % to 1.5 wt % citric acid based on the total weight of the composition, or about 0.3 wt % to 1.0 wt % citric acid based on the total weight of the composition; wherein the amount of the edible composition consumed by the Cervidae over a selected period of time is about 1.1 to 10 times (that is, 110% to 1000%) the amount consumed of the same composition without citric acid, or about 1.3 to 8 times, or about 1.5 to 7 times, or about 1.5 to 6 times, or about 1.5 to 5 times, or about 1.5 to 4 times, or about 1.5 to 3 times, or about 1.5 to 2 times, or about 1.1 to 2 times, or about 1.1 to 3 times, or about 1.1 to 4 times, or about 1.1 to 5 times, or about 1.1 to 6 times, or about 2 to 10 times, or about 3 to 10 times, or about 4 to 10 times, or about 5 to 10 times the amount consumed of the same composition without citric acid over a selected period of time. In some embodiments, the selected period of time is 12 hours, or 24 hours, or 48 hours, or 72 hours, or greater than 72 hours.

In some embodiments, a method of feeding wild or semi-wild ruminant mammals of the family Cervidae includes providing a first deer feed and a second deer feed to a selected location within an open, semi-enclosed, or large enclosed area, wherein the difference between the first deer feed and the second deer feed consists of the inclusion of citric acid in the feed, the first deer feed having no citric acid, the second deer feed being an edible composition having about 0.3 wt % to 1.5 wt % citric acid or 0.3 wt % to 1.0 wt % citric acid based on the total weight of the composition; wherein the deer consume about 1.1 to 10 times (that is, 110% to 1000%) the second deer feed compared to the first deer feed, or about 1.3 to 8 times, or about 1.5 to 7 times, or about 1.5 to 6 times, or about 1.5 to 5 times, or about 1.5 to 4 times, or about 1.5 to 3 times, or about 1.5 to 2 times, or about 1.1 to 2 times, or about 1.1 to 3 times, or about 1.1 to 4 times, or about 1.1 to 5 times, or about 1.1 to 6 times, or about 2 to 10 times, or about 3 to 10 times, or about 4 to 10 times, or about 5 to 10 times the amount consumed of the same composition without citric acid over a selected period of time. In some embodiments, the selected period of time is 12 hours, or 24 hours, or 48 hours, or 72 hours, or greater than 72 hours.

### EXAMPLES

The following examples are illustrative of the paste feed compositions of the invention. Additional examples and variations will be apparent to those of skill.

### Example 1

Feed formulations were blended employing the ingredients listed in Table 1.

TABLE 1
Ingredients in Example 1 feed and three Control examples C1-C3.

Example No.

| | C1 | C2 | C3 | 1 |
|---|---|---|---|---|
| Component | wt % | wt % | wt % | wt % |
| Cane molasses | 53.72 | 43.72 | 40.72 | 34.57 |
| Water | 22 | 27 | 30 | 35 |
| Tetrasodium | 0.03 | 0.03 | 0.03 | 0.03 |
| pyrophosphate | | | | |
| Attapulgite clay | 0.6 | 0.6 | 0.6 | 0.6 |
| Soy oil | 2 | 2 | 2 | 2 |
| Salt | 1.5 | 1.5 | 1.5 | 1.5 |
| Propionic acid | 0.15 | 0.15 | 0.15 | 0.30 |
| Citric acid | 0 | 0 | 0 | 1.00 |
| Rice Bran | 20 | 25 | 25 | 25 |
| TOTAL | 100 | 100 | 100 | 100 |

Molasses, water, tetrasodium pyrophosphate, and attapulgite clay were added to a 1 qt OSTERIZER® 10 speed blender (obtained from Sunbeam Products Inc. of Boca Raton, Fla.) and blended for two minutes. Then soy oil was added to the blender and the mixture was blended for an additional 30 seconds. Finally, salt, propionic acid, rice bran, and citric acid were added to the blender and the mixture was blended for an additional 60 seconds. The formulations were then poured out of the blender into jars and lids were applied. The formulations were allowed to stand for about 1 hour. Formulations C2 and C3 were too viscous to level on their own. Formulations C1, C3, and 1 were observed to flow after shaking the jars.

Using the same general procedure of addition and mixing, formulations C1, C3, and 1 were reformulated in 25 lb (11.3 kg) batches for feeding trials using a Myers mixer (obtained from Myers Engineering, Inc. of Bell, Calif.).

Formulations C1, C3, and 1 were fed to deer under the following test conditions. The 25 lb batch of each formulation was weighed into a black plastic tub and the tub was weighed to the nearest 0.01 lb. The tubs were placed about 20 feet apart in a private property in Comal County, TX having no high fences and having a large known herd of free-ranging native white-tailed deer in the vicinity. The tubs were weighed every 12 hours. After each weighing, each tub was placed in a different spot on the property, wherein the three tubs were always placed about 20 feet apart from one another. The test was ended when the first tub was empty.

The results of the feeding test are shown in Table 2.

TABLE 2
Amount of the feed mixtures of Examples C1, C3, and 1 ingested
by deer in the test area over a four day period.

| Ex. No., | | | | | |
|---|---|---|---|---|---|
| amount | Day | Day | Day | Day | Avg. per |
| ingested (kg) | 1 | 2 | 3 | 4 | day |
| C1 | 0.82 | 1.47 | 0.44 | 1.87 | 1.15 |
| C3 | 2.43 | 1.82 | 1.77 | 1.79 | 1.95 |
| 1 | 1.08 | 3.01 | 1.58 | 3.15 | 2.20 |

### Examples 2 and 3

Citric acid was blended with ANTLERMAX® Deer 20 (obtained from Purina Animal Nutrition, LLC of Shoreview, Minn.) at 0.5 wt % and 1.0 wt % based on total weight of the blend. Then ANTLERMAX® Deer 20 with no citric acid, Example C4, was compared to ANTLERMAX® Deer 20 with 0.5 wt % citric acid (Example 2) and ANTLERMAX® Deer 20 with 1.0 wt % citric acid (Example 3). The test lasted seven days. The results of the feeding test are shown in Table 3.

TABLE 3
Amount of the feed mixtures of Examples C4, 2, and 3 ingested
by deer in the test area over a seven day period.

| Ex. No., | | | | | | | | Avg. |
|---|---|---|---|---|---|---|---|---|
| amount | Day | Day | Day | Day | Day | Day | Day | per |
| ingested (kg) | 1 | 2 | 3 | 4 | 5 | 6 | 7 | day |
| C4 | 2.00 | 4.49 | 4.35 | 5.53 | 13.02 | 11.93 | 1.41 | 6.12 |
| 2 | 15.24 | 14.24 | 15.74 | 17.33 | 15.65 | 23.27 | 6.94 | 15.47 |
| 3 | 9.75 | 10.84 | 10.84 | 13.02 | 14.38 | 23.10 | 4.85 | 12.38 |

Although the present disclosure provides references to preferred embodiments, persons skilled in the art will recognize that changes may be made in form and detail without departing from the spirit and scope of the invention. The invention illustratively disclosed herein can be suitably practiced in the absence of any element which is not specifically disclosed herein. While the invention is susceptible to various modifications and alternative forms, specifics thereof have been shown by way of examples, and are described in detail. It should be understood, however, that the invention is not limited to the particular embodiments described. On the contrary, the intention is to cover modifications, equivalents, and alternatives falling within the spirit and scope of the invention.

Additionally each and every embodiment of the invention, as described here, is intended to be used either alone or in combination with any other embodiment described herein. In various embodiments, the invention suitably comprises, consists essentially of, or consists of the elements described herein and claimed according to the claims appended below. It will be understood that “consisting essentially of” recited in a preamble to a claim means that the claim is limited to the specified materials or steps and those that do not materially affect the basic and novel characteristic(s) of the claimed invention.

What is claimed is:

1. A deer feed composition comprising at least one carbohydrate, at least one fat, and about 0.3 wt % to 1.5 wt % citric acid based on the total weight of the composition.

2. The deer feed composition of claim 1 wherein the carbohydrate comprises rice bran.

3. The deer feed composition of claim 2 wherein the composition comprises about 25 wt % rice bran based on the total weight of the composition.

4. The deer feed composition of claim 1 wherein the carbohydrate comprises a sugar-containing component comprising molasses.

5. The deer feed composition of claim 4 wherein the composition comprises about 30 wt % to 45 wt % molasses based on the total weight of the composition.

6. The deer feed composition of claim 1 wherein the fat comprises a plant oil.

7. The deer feed composition of claim 6 wherein the plant oil comprises soy oil, wherein the composition comprises about 1 wt % to 5 wt % soy oil based on the total weight of the composition.

8. The deer feed composition of claim 1, consisting essentially of
about 55 wt % to 70 wt % total carbohydrate, the carbohydrate comprising rice bran and molasses;
about 2 wt % total fat, the fat comprising soy oil;
about 1.5 wt % sodium chloride;
about 0.3 wt % propionic acid;
about 0.5 wt % citric acid; and
optionally one or more viscosifiers, a buffer, one or more airborne attractants, one or more foaming agents, one or more stabilizers, or a combination thereof.

9. The composition of claim 8 wherein the viscosifier comprises agar, xanthan gum, locust bean gum, carrageenan, or a combination thereof.

10. A deer attractant composition comprising at least one carbohydrate, one or more airborne attractant, and about 0.3 wt % to 1.5 wt % citric acid based on the total weight of the composition.

11. The deer attractant of claim 10 wherein the airborne attractant comprises one or more of estrous, urine, a plant extract a nut extract, a seed extract, or an ester attributed to a green plant or fruit odor.

12. The deer attractant of claim 10 wherein the carbohydrate comprises a sugar-containing component comprising molasses.

13. The deer attractant of claim 10 further comprising a viscosifier comprising agar, xanthan gum, or a combination thereof.

14. The deer attractant of claim 10 further comprising a foaming agent, the foaming agent comprising sodium bicarbonate.

15. A method of establishing a pattern of returning behavior in a wild or semi-wild ruminant mammal of the family Cervidae, the method comprising placing an edible composition at one or more selected locations within an open, semi-enclosed, or large enclosed area, the edible composition comprising at least one carbohydrate and about 0.3 wt % to 1.0 wt % citric acid based on the total weight of the composition; wherein the amount of the edible composition consumed by the Cervidae over a selected period of time is 1.1 to 10 times the amount consumed of the same composition without citric acid.

16. A method of feeding wild or semi-wild deer, the method comprising providing a first deer feed and a second deer feed to a selected location within an open, semi-enclosed, or large enclosed area, wherein the difference between the first deer feed and the second deer feed consists of the inclusion of citric acid in the feed, the first deer feed having no citric acid, the second deer feed having about 0.3 wt % to 1.0 wt % citric acid; wherein the deer consume 1.1 to 10 times the amount of the second deer feed compared to the first deer feed over a selected period of time.
